(19) United States
(12) Patent Application Publication
(10) Pub. No.: US 2009/0311465 A1
(43) Pub. Date: Dec. 17, 2009

(54) STRETCHABLE LAMINATE

(76) Inventor: Johannes H. A. De Jong, Lichtaart (BE)

Correspondence Address: Avery Dennison Corporation;Amanda Wittine, 8080 Norton Parkway, 22-D, Mentor, OH, 44060, US

(21) Appl. No.: 12/136,817

(22) Filed: Jun. 11, 2008

(51) Int. Cl. B32B 3/06; B32B 38/04

(52) U.S. Cl. 428/101; 156/268

(57) ABSTRACT

A stretchable laminate (10) comprising at least one nonelastic fabric layer (20/30) and an elastic layer (40) laminated thereto. The fabric layer(s) (20/30) have interruptions (22/32) formed therein which extend 10% to 99% through the layer thickness thereby rendering the laminate (10) stretchable. The stretchable laminate (10) can be incorporated into a diaper component, or it can serve as an intermediate laminate in a method for making an elastic, or more elastic, laminate.

### RELATED APPLICATIONS

This application claims priority under 35 U.S.C. §120 to International Application Nos. PCT/U.S.07/77367 filed Aug. 31, 2007; PCT/U.S.07/77349 filed Aug. 31, 2007; PCT/U.S.07/77359 filed Aug. 31, 2007 (which claimed priority to U.S. Provisional Patent Application Nos. 60/941,402 filed Jun. 1, 2007; 60/913,059 filed Apr. 20, 2007; 60/824,261 filed Aug. 31, 2006; 60/941,420 filed Jun. 1, 2007; 60/912,983 filed Apr. 20, 2007; 60/862,252 filed Oct. 20, 2006; 60/941,431 filed Jun. 1, 2007; 60/913,048 filed Apr. 20, 2007). The entire disclosures of these international and provisional applications are hereby incorporated by reference. If incorporated-by-reference subject matter is inconsistent with subject matter expressly set forth in the written specification and drawings of this disclosure, the latter governs to the extent necessary to eliminate indefiniteness and/or clarity-lacking issues.

### BACKGROUND

A stretchable laminate, comprising an elastic layer and one or more fabric layers, can be used in a variety of situations where elasticity is required or desired for one reason or another. For example, in the field of disposable absorbent articles (e.g., diapers, incontinence briefs, etc.), an elastic laminate can be used as, or incorporated into, a side panel or belt for attachment to a rear chassis portion. A fastening tape, for attaching a rear chassis portion to a front chassis portion, can also comprise a stretchable laminate. A stretchable laminate can be used to form the diaper/brief chassis itself, or portions/regions thereof (e.g., waist regions in a front/rear chassis portion, leg-opening regions in a crotch chassis portion, etc.) With these and other applications, it is often necessary or desirable to use a fabric layer (e.g., a nonwoven fabric layer) as the next-to-the-skin layer and/or the exposed layer.

### SUMMARY

A stretchable laminate comprises an elastic layer (made of an elastic material that has recoverable elongation properties) and at least one fabric layer. Interruptions (e.g., cuts, slits, scores, etc.) are formed in the fabric layer(s), these interruptions extending about 10% to about 99% through the thickness of the fabric layer, thereby rendering the laminate stretchable. Even with nonelastic fabric layers (e.g., nonelastic nonwoven layers), the laminate still provides sufficient stretchability and/or elasticity.

The stretchability and/or elasticity of the stretchable laminate is obtained without the need for conventional activation steps such as stretching, ring rolling, and/or tension-induced tearing. Thus, the structural deficiencies associated with activation (e.g., snapping caused by damaged elastic layers, reduced resiliency/recovery due to pre-elongation, matrix weakness imposed by breaks/tears, etc.) and the manufacturing complications caused by activation (e.g., inconvenience of pre-tensioning or necking steps, clumsy compilation procedures due to layer elongation, extreme precision necessary to prevent elastic damage, high elastic extrusion standards to avoid susceptible weak gel-particle-surrounding spots, time-consuming repetition of ring rolling steps, etc.) may advantageously be eliminated with the stretchable laminate.

That being said, the stretchable laminate with the partial interruptions may instead serve as an intermediate product in the production of an elastic, or more elastic, laminate. Specifically, the tendons forming the uninterrupted extensions of the interruptions (e.g., uncut extension of cut line, unslit extension of slit line, unscored extension of score line) can be ruptured in a further production step. If most and/or all of the tendons are ruptured, the fabric layer will comprise separate fabric segments attached to the elastic layer which diverge upon laminate elongation and converge upon laminate recovery.

### DRAWINGS

FIGS. 1A-1C are a plan view and side views of a stretchable laminate, the laminate comprising a fabric layer and an elastic layer, the fabric layer having a series of distal interruptions extending partially through the fabric layer, the laminate being shown in a relaxed state in FIGS. 1A and 1B, and in an elongated state in FIG. 1C.

FIG. 1D is a close-up view of an interruption in the stretchable laminate shown in FIGS. 1A-1C.

FIG. 1E-1G are a plan view and side views of a stretchable laminate, the laminate comprising a fabric layer and an elastic layer, the fabric layer having a series of proximal interruptions which extend partially through the fabric layer, the laminate being shown in a relaxed state in FIGS. 1E and 1F, and in an elongated state in FIG. 1G.

FIG. 1H is a close-up view of an interruption in the stretchable laminate shown in FIGS. 1E-1G.

FIGS. 2A-2H are side views of some other possible interruption patterns.

FIGS. 3A-3I are plan views of some other possible interruption patterns.

FIGS. 4A-4F are close-up views of the stretchable laminate showing some other possible interruption path geometries.

FIGS. 5A-5C are schematic views of some possible methods of making the laminate.

FIGS. 6A-6E are side views of stretchable laminates comprising two fabric layers.

FIGS. 6F and 6G are each a close-up view of an interruption in the second fabric layer.

FIGS. 7A-7H are schematic views of some possible methods of making a two-fabric-layer laminate.

FIGS. 8A-8Q are schematic views of some further possible methods of making a two-fabric-layer laminate.

FIGS. 9A-9L are schematic views of some possible techniques for laminating the elastic layer and the fabric layer(s).

FIGS. 10A-10C are a plan view and side views of an elastic laminate, the laminate comprising a fabric layer and an elastic layer, the laminate including pairs of aligned proximal and distal interruptions which together extend through the thickness of the fabric layer(s), the laminate being shown in a relaxed state in FIGS. 10A and 10B, and in an elongated state in FIG. 10C.

FIGS. 10D-10G are each close-up views of a pair of the interruptions in the fabric layer.

FIGS. 10H and 10I are magnified representations of a ruptured interruption and a severed interruption, respectively.

FIGS. 11A-11F are plan views of side panels including a stretchable laminate, and FIGS. 11G and 11H are plan views of absorbent disposable articles each of which includes a pair of side panels.

FIGS. 12A-12C are plan views of fastening tapes including a stretchable laminate, and FIGS. 12D and 12E are plan views of absorbent disposable articles each of which includes a pair of such fastening tapes.

FIGS. 13A-13G are plan views of belts including a stretchable laminate, and FIG. 13F is a plan view of an absorbent disposable article including a pair of such belts.

FIG. 14 is a plan view of an absorbent disposable article including a stretchable laminate.

### DETAILED DESCRIPTION

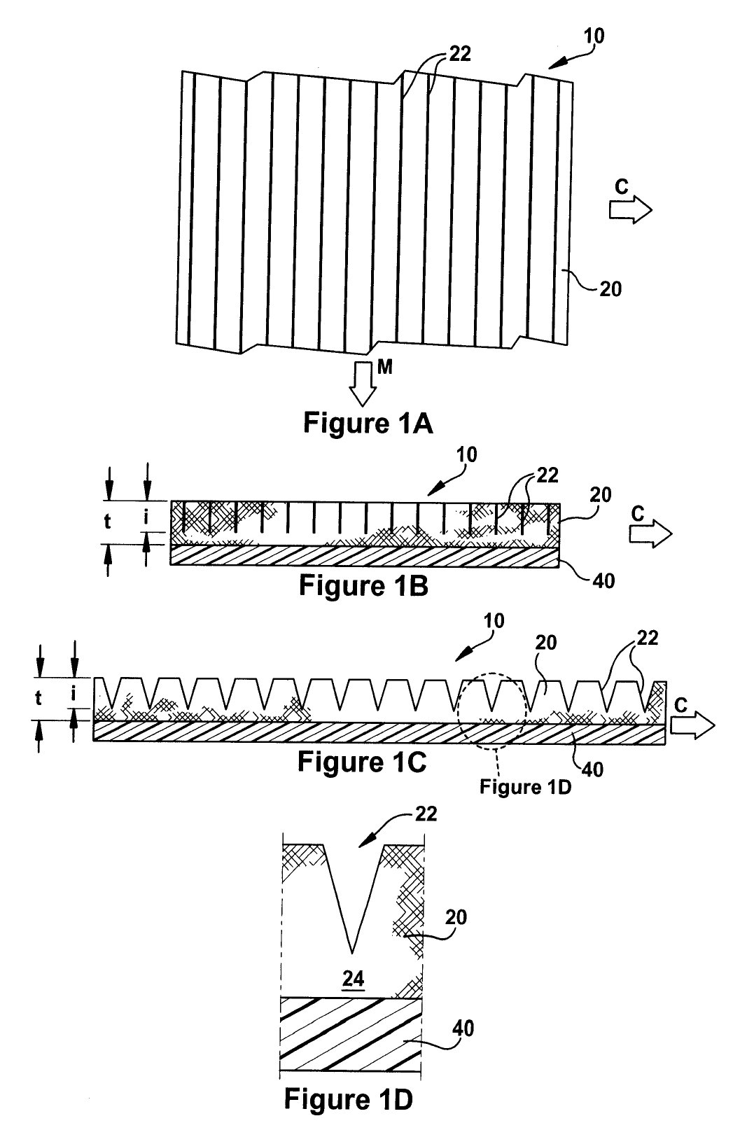

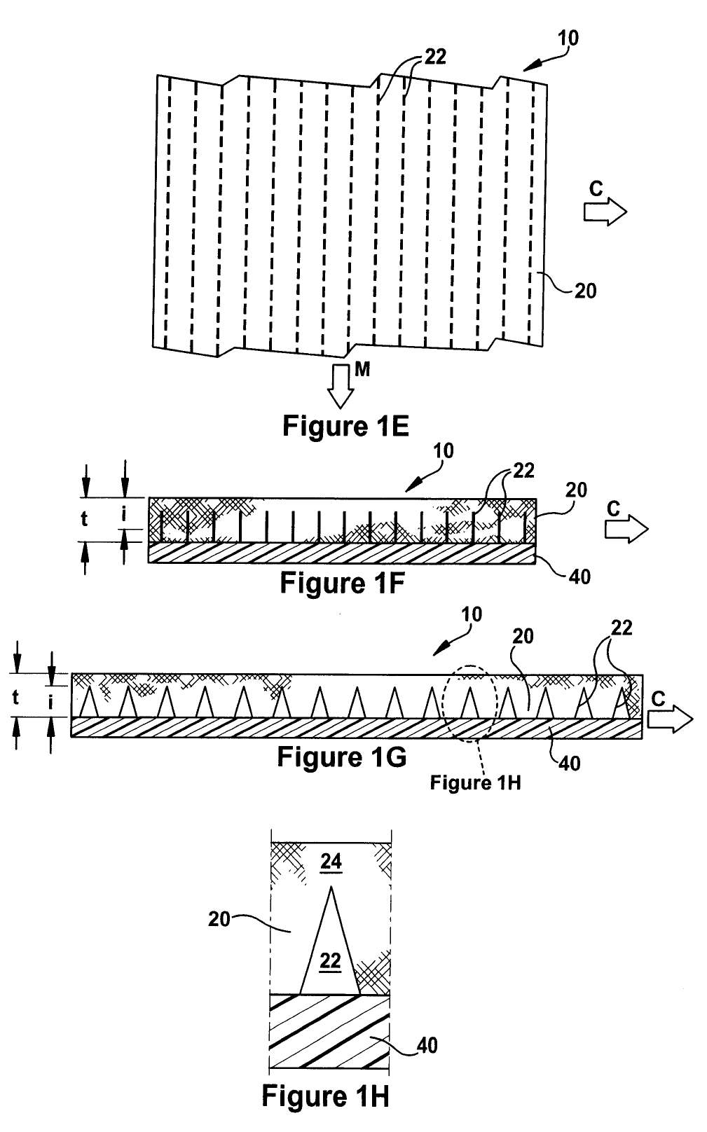

Referring now to the drawings, and initially to FIGS. 1A-1C and FIGS. 1E-1G, a stretchable laminate 10 is shown. The laminate 10 comprises a first fabric layer 20 and an elastic layer 40 laminated thereto. The first fabric layer 20 can be a nonelastic layer and, more particularly, a nonwoven nonelastic layer. The elastic layer 40 is made of an elastic material that has recoverable elongation properties in a direction C which is cross (e.g., substantially perpendicular) to the machine direction M. The thicknesses of the layers 20 and 40 (and also the fabric layer 30 introduced below) are greatly exaggerated in the drawings for ease of explanation. The thicknesses of these layers will usually be in the range of, for example, about 2.5 micrometers to about 100 micrometers or more. If these thicknesses were drawn to scale with the illustrated lengths, it would be difficult to decipher and/or number the layers.

The first fabric layer 20 has interruptions 22 formed therein which extend only partially through the layer thickness (i.e., the percentage of the dimension i to the dimension t is less than 100%). For example, the interruptions 22 may extend 10% to 99%, 20% to 99%, 30% to 99%, 40% to 99%, 50% to 99%, 60% to 99%, and/or 70% to 99% through the thickness of the fabric layer 20. The interruptions 22 can be, for example, die cuts, kiss cuts, slits, scores, laser cuts, and/or ultrasound cuts. The interruptions 22 allow the first fabric layer 20 to expand upon elongation of the elastic layer 40 (FIG. 1C and FIG. 1G) and contract upon recovery of the elastic layer 40 (FIG. 1B and FIG. 1F), thereby rendering the laminate 10 stretchable in the cross direction C.

If the elastic layer 40 is used as a reference layer, the fabric layer 20 will have a proximal side located closest to the elastic layer 40 and a distal side located away from the elastic layer. The thickness of the fabric layer 20 is the distance between its proximal and distal sides. In FIGS. 1A-1C, the interruptions 22 are distal interruptions in that they extend through the distal side of the fabric layer 20, but not the proximal side of this fabric layer. In FIGS. 1E-1G, the interruptions 22 are proximal interruptions in that they extend through the proximal side of the fabric layer 20, but not the distal side of this fabric layer 20. Although not specifically shown in the drawings, it is possible for the fabric layer 20 to have both distal interruptions and proximal interruptions, provided they are not aligned so as cause the interruptions 22 to extend completely through the fabric thickness.

As is best seen by referring additionally to FIGS. 1D and 1H, the first fabric layer 20 has tendons 24 extending from the interruptions 22 through the remaining percentage of the layer thickness. For example, if the interruption 22 is a cut/slit/score, the tendon 24 is an uncut region of the cut/slit/score line. In FIGS. 1A-1D, the tendons 24 extend from the proximal side of the fabric layer 20 and to the distal interruptions 22. In FIGS. 1E-1H, the tendons 24 extend from the distal side of the fabric layer 20 to the proximal interruptions 22.

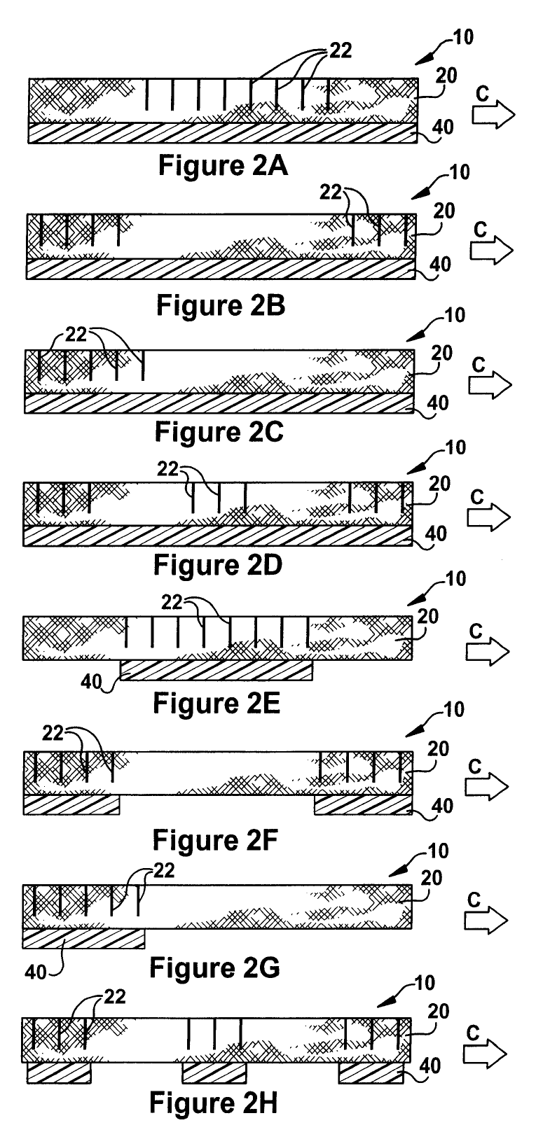

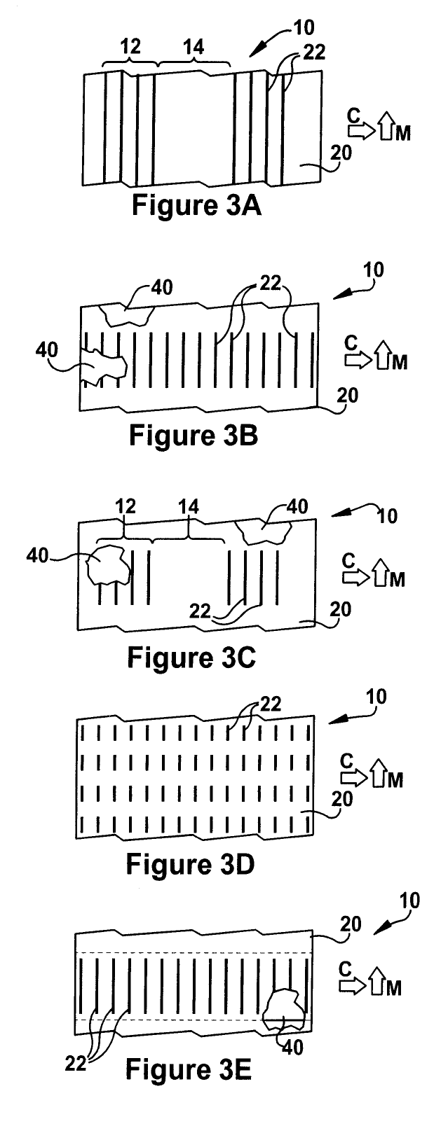

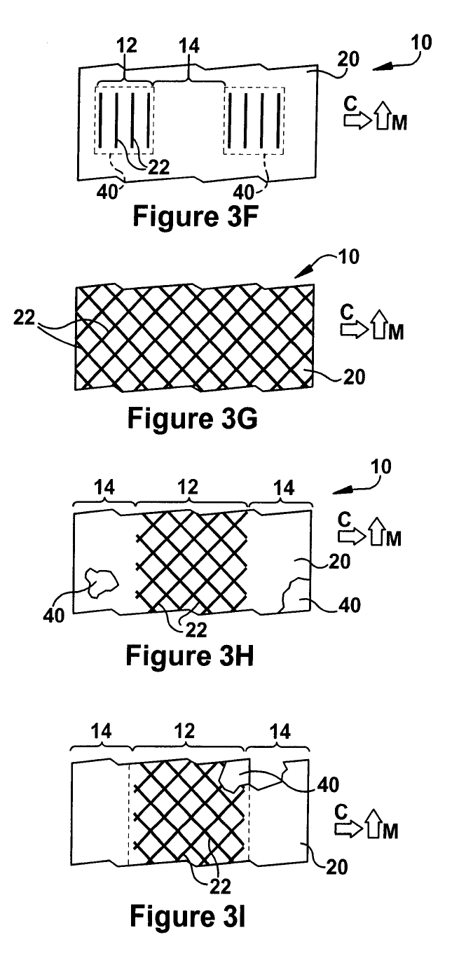

FIGS. 1A-1C and FIGS. 1E-1G show one possible pattern for the interruptions 22. FIGS. 2A-2H and FIGS. 3A-3I showing other possible interruption patterns. As shown in FIG. 1A-1C and FIGS. 1E-1G, the interruptions 22 can continuously extend across the span of the cross direction C. (See also FIGS. 3B, 3E, and 3G.) As shown in FIGS. 2A-2H, the interruptions 22 need not extend continuously across the span of the cross direction C. (See also FIGS. 3A, 3C, 3F, 3H and 3I.) In either case, adjacent interruptions 22 can be spaced apart (evenly or unevenly) a distance of between about 1 millimeter and about 10 millimeters in the cross direction C. Although the second series of drawings specifically show distal interruptions (e.g., FIGS. 1A-1D), they apply equally to proximal interruptions (e.g., FIGS. 1E-1H).

The elastic layer 40 can be coextensive with the first fabric layer 20 in the cross direction C (FIG. 1A, FIG. 1E, and FIGS. 2A-2D) or non-coextensive with the first fabric layer 20 in the cross direction C (FIGS. 2E-2H). The interruptions 22 can be coextensive with the elastic layer 40 (FIG. 1A, FIGS. 1E and 2E-2H) or non-coextensive with the elastic layer 40 (FIGS. 2A-2D) in the cross direction. With particular reference to FIG. 2E and/or FIG. 2H, the interruptions 22 can not extend beyond the extent of the elastic layer 40 in the cross direction C. The interruptions 22 can extend almost, but not quite the full cross-extent of the elastic layer 40 on each side, thereby leaving an uninterrupted margin aligned with each lateral edge of the elastic layer 40. This latter option may be desirable to, for instance, securely attach the elastic layer 40 to the fabric layers 20/30. Margin widths in the range of 2-20 millimeters, 4-12 millimeters, and/or 6-10 millimeters may be sufficient for this purpose.

As shown in FIG. 1A, FIG. 1E, and FIGS. 3A, 3D, and 3G, the interruptions 22 can extend continuously in the machine direction M. As shown in FIGS. 3B, 3C, 3E, 3F, 3H and 3I, the interruptions 22 need not extend continuously in the machine direction M. The elastic layer 40 can be coextensive with the fabric layer 20 in the machine direction M (FIGS. 3A-3D and FIGS. 3G-3I) or the elastic layer 40 can be non-coextensive with the fabric layer 20 in the machine direction M (FIG. 3E and FIG. 3F). The interruptions 22 can be coextensive with the elastic layer 40 (FIGS. 3D, 3E, 3F and 3I) or the interruptions can be non-coextensive with the elastic layer 40 (FIGS. 3A-3C and FIG. 3H) in the machine direction M.

The interruptions 22 can elongate and extend in a direction non-parallel to the cross direction C. For example, the interruptions 22 can extend substantially parallel to the machine direction (FIGS. 3A-3F). Alternatively, the interruptions 22 can extend an acute angle (e.g., about 10° to about 75°, about 10° to about 60°, and/or about 10° to about 45°) relative to the machine direction M (FIGS. 3G-3I) and these interruptions 22 can (but need not) intersect. Although not specifically shown in the drawings, the paths of the interruptions 22 can include both paths substantially parallel to the machine direction M and paths at an acute angle relative to the machine direction M. The parallel and angularly offset paths can (or cannot) intersect.

In other words, the laminate 10 can have interrupted zones 12 and uninterrupted zones 14 (with the interruptions 22 being located only in the interrupted zones 12). The elastic layer 40 can be coextensive with both the interrupted zones 12 and the uninterrupted zones 14 (FIGS. 2A-2D, FIGS. 3A-3C, and FIG. 3H) or the elastic layer 40 can be substantially coextensive with only the interrupted zones 12 in the cross direction C and/or the machine direction M (FIGS. 2E-2H, FIGS. 3E-3F and FIG. 3I). The earlier option may ease layer compilation steps in certain situations; the latter option may reduce material costs.

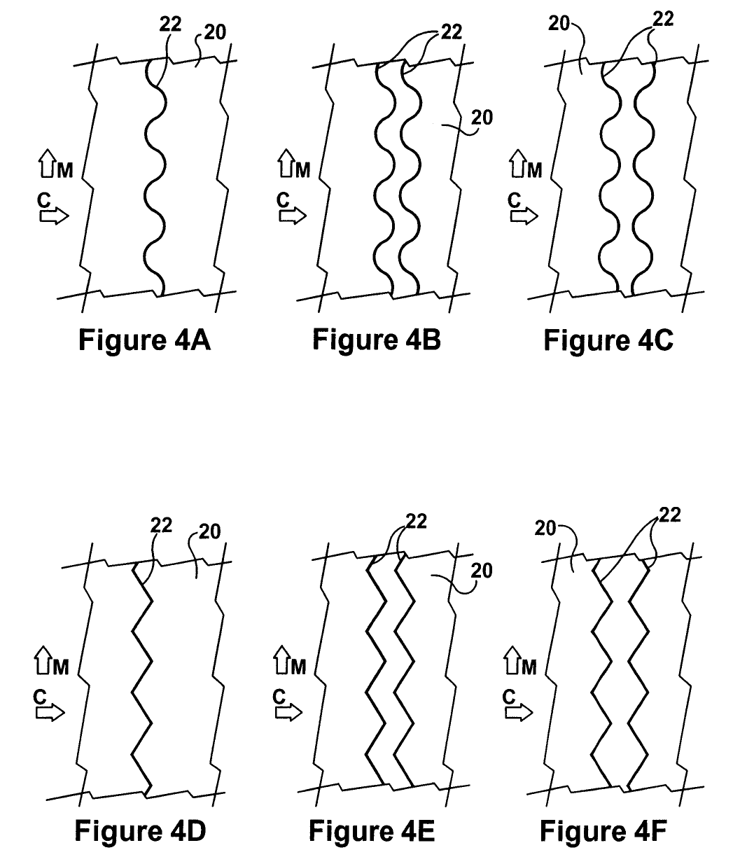

In the first through third series of drawings, the interruptions 22 were illustrated as following a linear path, however the paths need not always be linear. The interruptions 22 can follow a sinusoidal path (FIGS. 4A-4C) or a zigzag path (FIGS. 4D-4F), with adjacent interruptions being either aligned with each other (FIGS. 4B and 4E) or offset from each other (FIGS. 4C and 4F). In the case of nonlinear paths, the angle of the interruption 22 relative to the machine direction M can be determined by the centerline of the path.

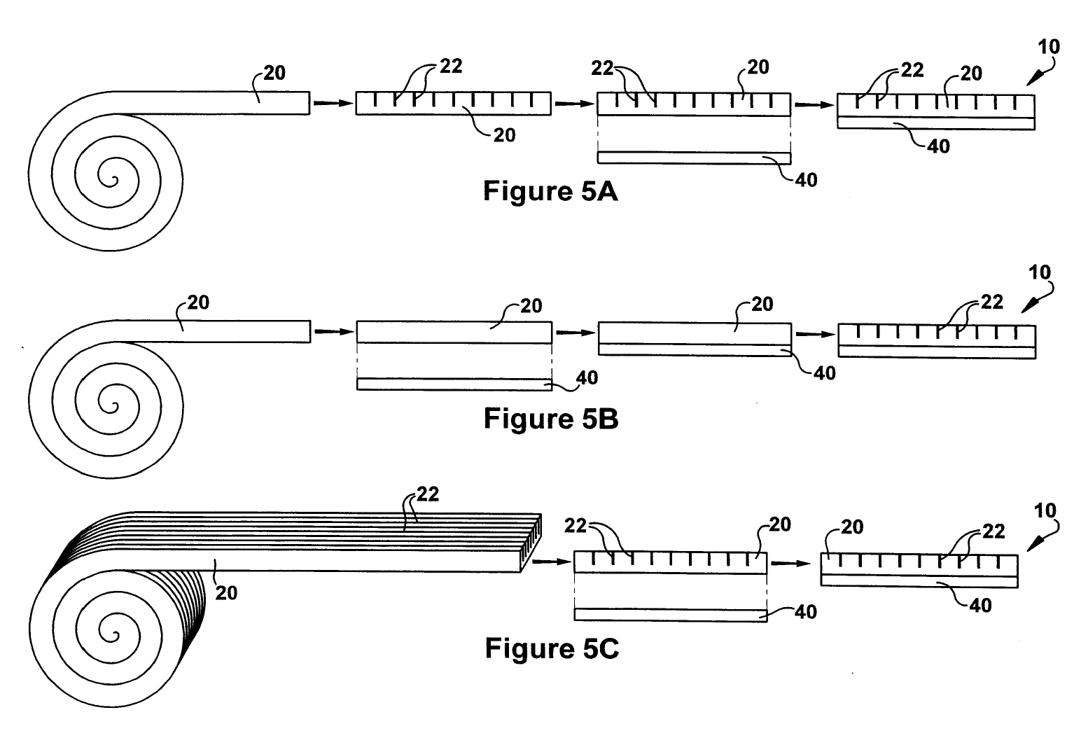

Referring now to FIGS. 5A-5C, some possible methods for making the stretchable laminate 10 of FIGS. 1A-1C are schematically shown. (In this fifth series of drawings, the supply of the first fabric layer 20 is shown in the machine direction M, while the subsequent interruption forming and/or laminating steps are shown in the cross direction C for clarity and ease in explanation.) A method for making the laminate 10 can comprise the steps of forming the interruptions 22 in the first fabric layer 20 and laminating the first fabric layer 20 and the elastic layer 40. The interruption-forming step can be performed prior to the first-fabric-laminating step (FIG. 5A), or the first-fabric-laminating step can be performed prior to the interruption-forming step (FIG. 5B). A cut/slitted/scored fabric layer 20 can be assembled into a format suitable for continuous supply (e.g., a roll) and then laminated to the elastic layer 40 (FIG. 5C).

If proximate interruptions are to be formed in the fabric layer 20 after lamination (FIG. 5B), such formation would have to be done without damaging the elastic layer 40. This may prove difficult with physically-contacting cutting elements, such as blades, knives, or slitting wheels. However, with the use of laser, ultrasound, and/or other more precise cutting procedures, post-laminate formation of the interruptions 22 may be possible and even preferred. For example, with laser cutting, (e.g., where carbon dioxide laser beams are delivered via scanner systems with final focusing optics), the cutting depth can be closely controlled by altering the power of the laser. For this same reason, pre-lamination formation of the interruptions 22 with laser, ultrasound, or other non-contacting cutting techniques may be best if a facility is accommodated with the necessary equipment.

If proximate interruptions are to be formed in the fabric layer 20, (e.g., the stretchable laminate 10 shown in FIGS. 1E-1G) performing the interruption-forming steps prior to the laminating step may prove to be most practical. (FIGS. 5A and 5C). That being said, laser, ultrasound or other sophisticated cutting systems could conceivably be used to form such proximate interruptions post-lamination.

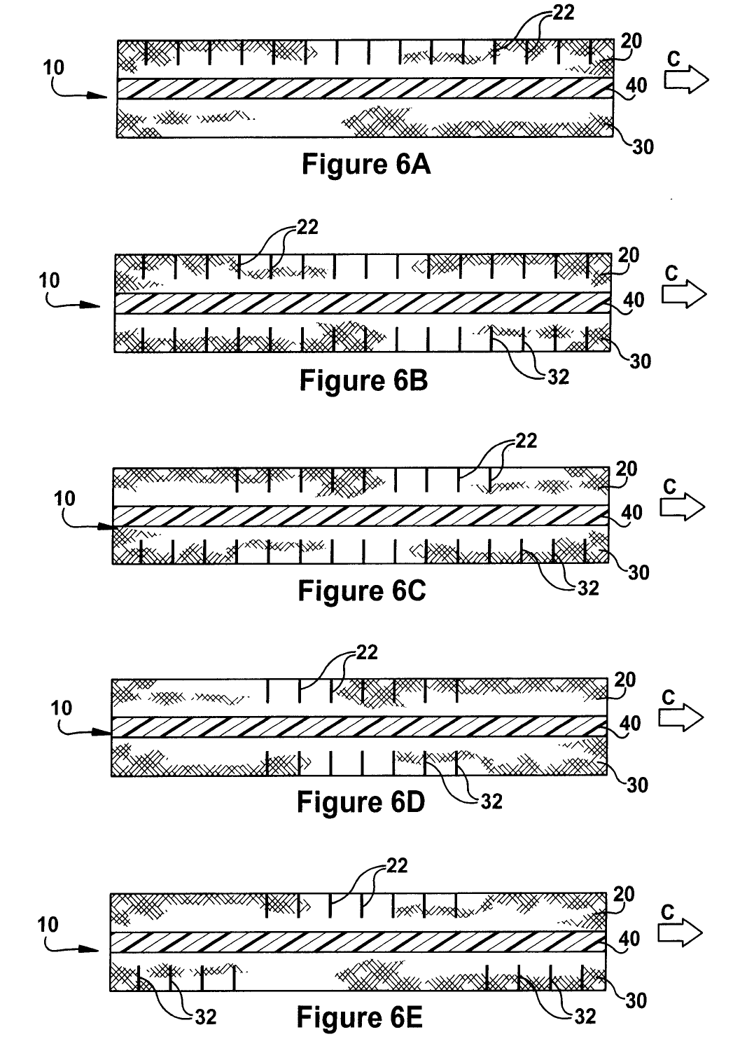

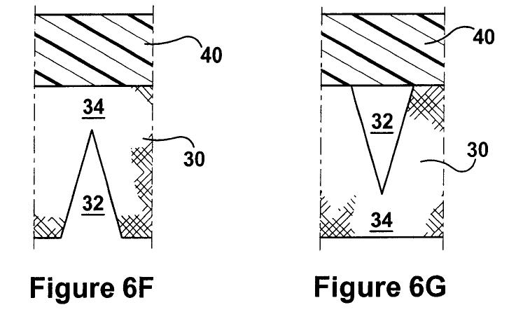

Referring now to FIGS. 6A-6E, the stretchable laminate 10 can comprise a second fabric layer 30, with the elastic layer 40 sandwiched between the first fabric layer 20 and the second fabric layer 30. Usually, but not necessarily, the second fabric layer 30 will have the same width (i.e., dimension in the machine direction M) as the first fabric layer 20. If the second fabric layer 30 is an elastic fabric layer (e.g., an elastic nonwoven layer), interruptions may not be necessary.

If the second fabric layer 30 is a nonelastic fabric layer (e.g. a nonelastic nonwoven layer), interruptions 32 can be provided to further render the laminate 10 stretchable in the cross direction C. The interruptions 32 can have the same or similar features (e.g., thickness, spacing, zoning, coextension, path geometry, etc.) as the interruptions 22 whereby the fabric 30 could be mirror form of the fabric 20 relative to the elastic layer 40. Thus, the fabric 30 could have any or all of the features of the fabric 20, such as those shown and/or described in connection with FIGS. 2A-2H. Additionally or alternatively, the interruptions 32 can substantially align with the interruptions 22 (FIGS. 6B-6D), overlap/underlap the interruptions 22 (FIG. 6C), or staddle the interruptions 22 (FIG. 6E). Although the interruptions 22/32 are shown in FIGS. 6A-6E as proximal interruptions either or both could instead be distal interruptions and/or the fabric layers 20/30 could either or both include both distal interruptions and proximal interruptions.

As is best seen by referring additionally to FIGS. 6F and 6G, the fabric layer 30 will include tendons 34 extending from the interruptions 32 through the remaining percentage the layer thickness. In FIG. 6F the tendon 34 extends from the proximal side of the fabric layer 30 to the distal interruption 32. In FIG. 6G, the tendon 34 extends from the distal side of the fabric layer 30 to the proximal interruption 32.

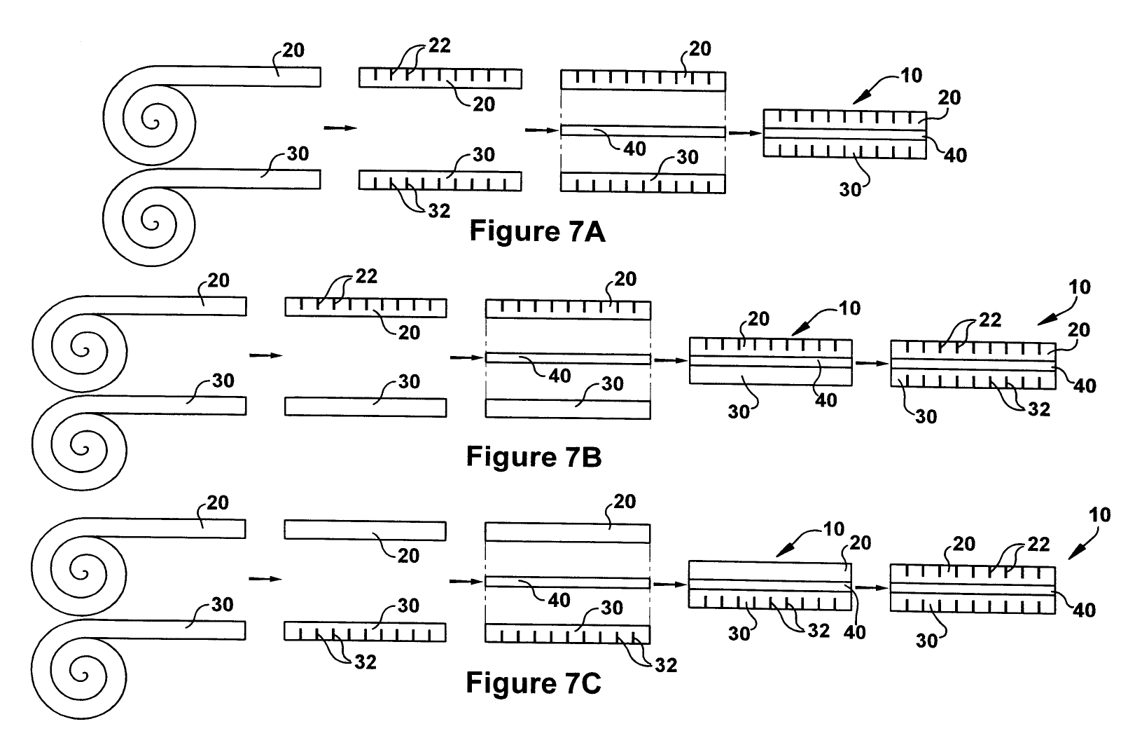

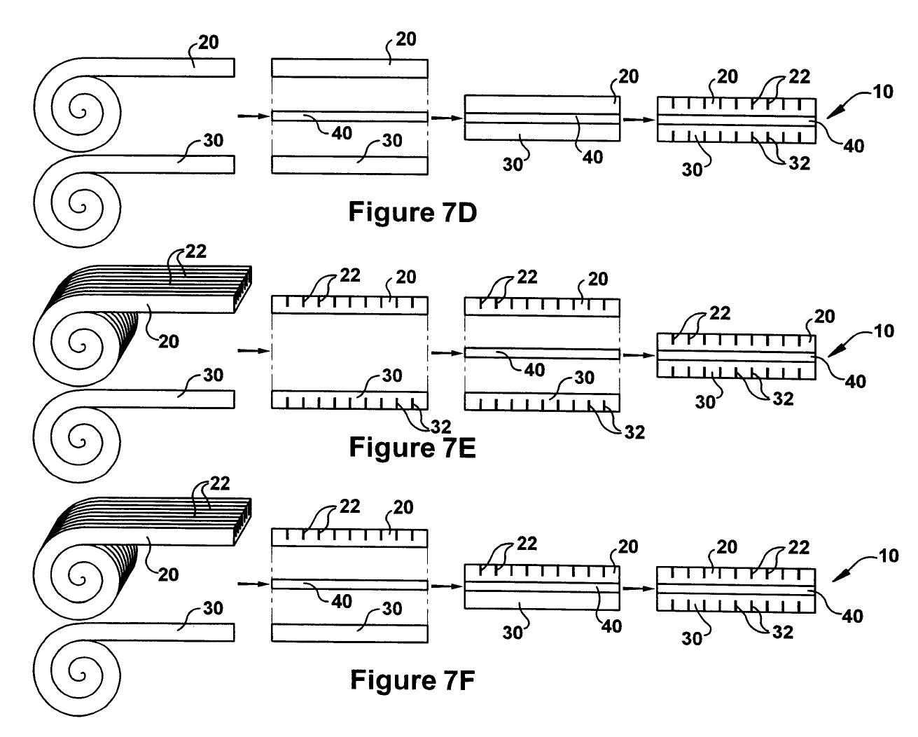

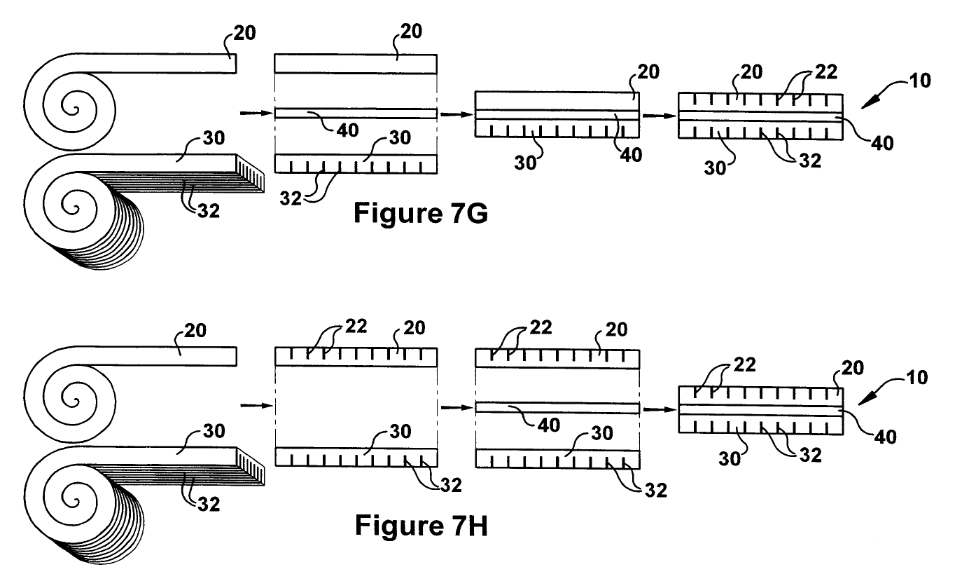

Referring now to FIGS. 7A-7H, some possible methods for making the two-fabric-layer laminate 10 are shown. (Again, the continuous supply of the fabric layer(s) 20/30 is shown in the machine direction M, while the subsequent interruption forming and/or laminating steps are shown in the cross direction C for clarity and ease in explanation.) The method can comprise the steps of forming the interruptions 22 in the first fabric layer 20, and laminating the layers 20/30/40 together. If the second fabric layer 30 is an elastic layer (FIG. 6A), and no interruptions are necessary, further steps may not be required. If the second fabric layer 30 is to be interrupted, the method will comprise the further step of forming interruptions 32 in the second fabric layer 30. (FIGS. 7A-7H.)

The interruption-forming steps can be performed prior to laminating steps (FIG. 7A), before and after the laminating steps (FIGS. 7B and 7C), or after the laminating steps (FIG. 7D). (Although, again, interruption-forming steps done after lamination may prove difficult for proximal interruptions.) The first fabric layer 20, with the interruptions 22 already formed therein, can be assembled into a format suitable for continuous supply (e.g., a roll) (FIGS. 7E and 7F), and the second-fabric-interruption-forming step can be performed before (FIG. 7E) or after (FIG. 7F) the laminating steps. Alternatively, the second fabric layer 30, with the interruptions 32 already formed therein, is assembled into a format suitable for continuous supply (e.g., a roll) (FIGS. 7G and 7H) and the first-fabric-interruption-forming step can be performed after (FIG. 7G) or before (FIG. 7H) the laminating steps. The fact that the interruptions 22/32 extend only partially through the thickness of the fabric layers 20/30, expedites the interruption-forming steps and the laminating steps when compared to, for example, interruptions extending completely through (i.e. 100%) the fabric layer thicknesses.

With particular reference to the methods wherein at least one fabric-interruption-forming step is performed after lamination (FIGS. 7B-7D, and 7F-7G), the use of laser or ultrasound cutting methods (wherein cutting depth can be closely controlled) may minimize the risk of damage to the elastic layer 40. Additionally or alternatively, such non-contacting cutting techniques can usually accommodate precise optical registration procedures, which may be necessary if alignment between the interruptions 22/32 is desired or necessary.

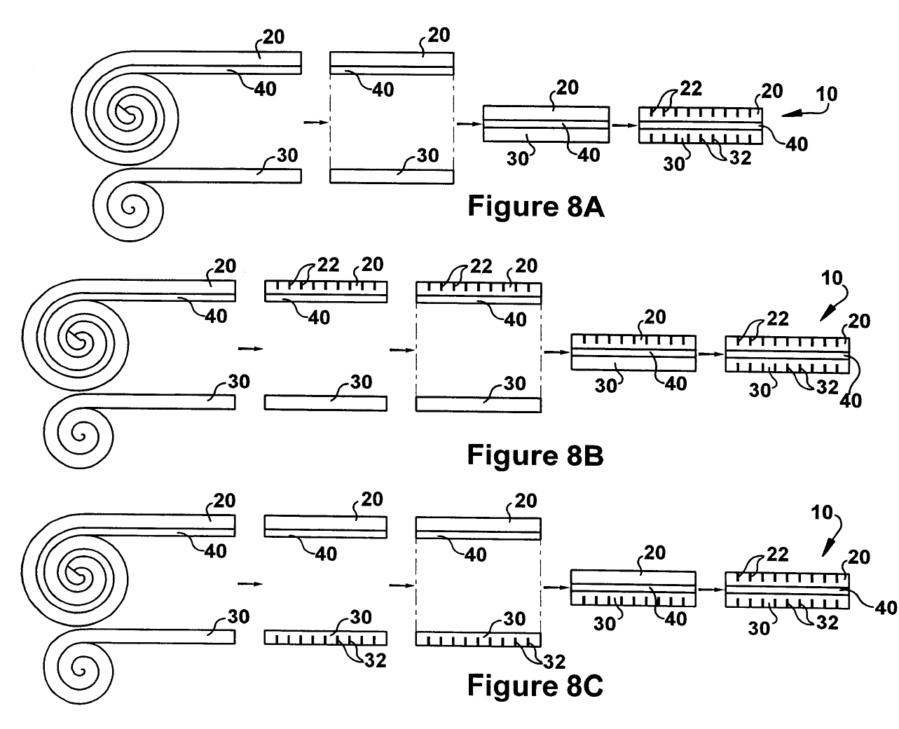

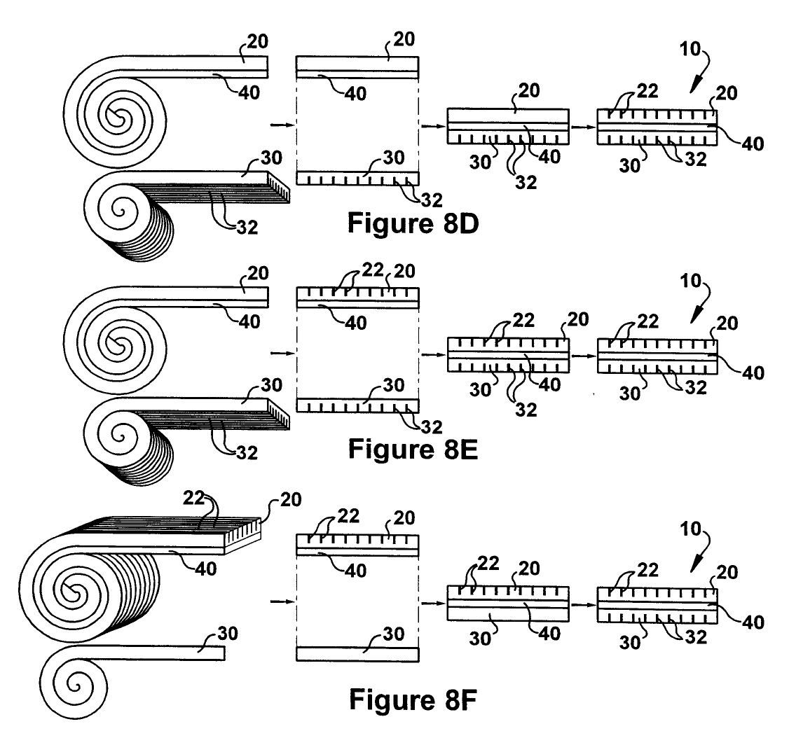

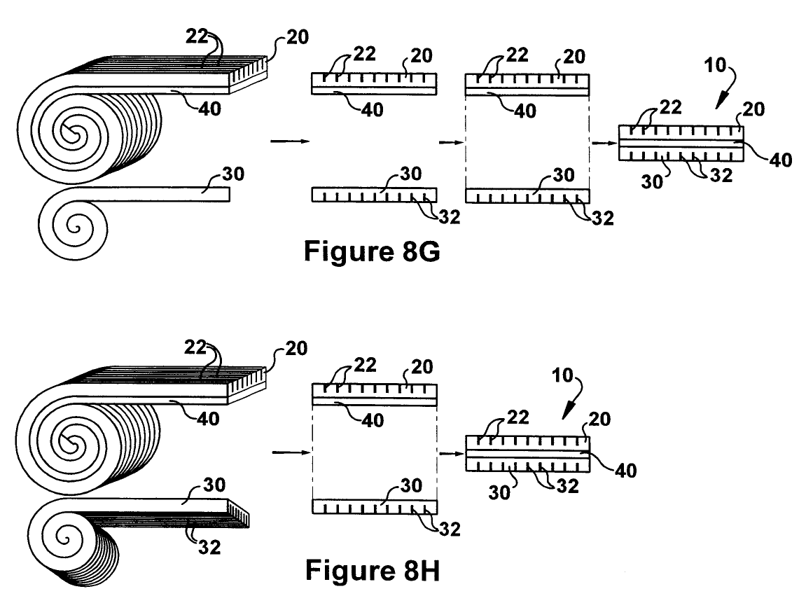

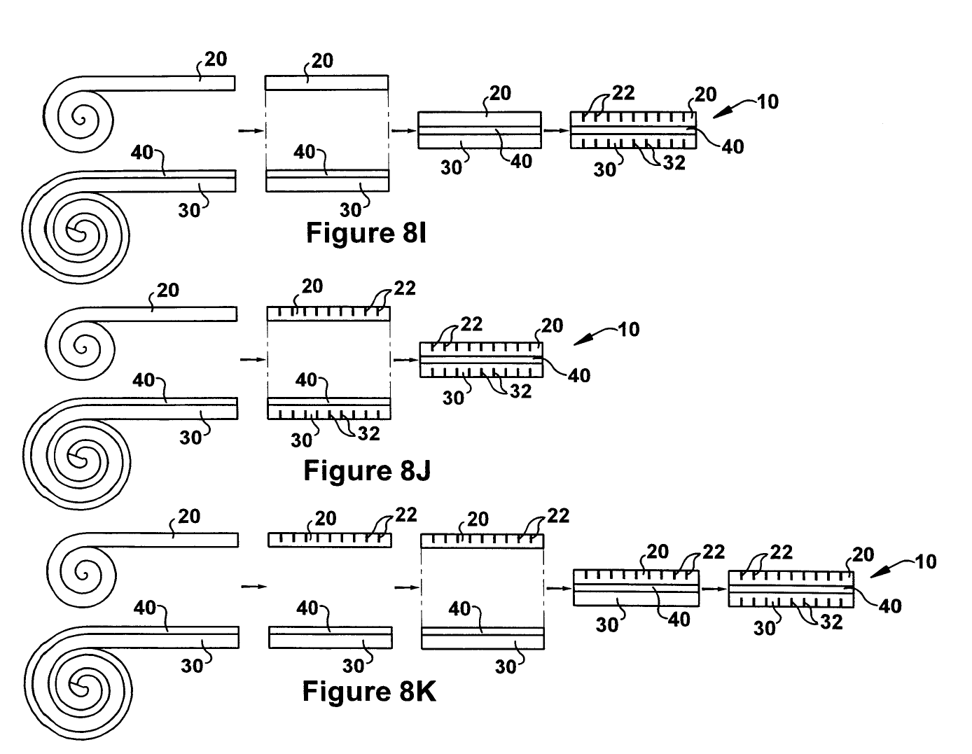

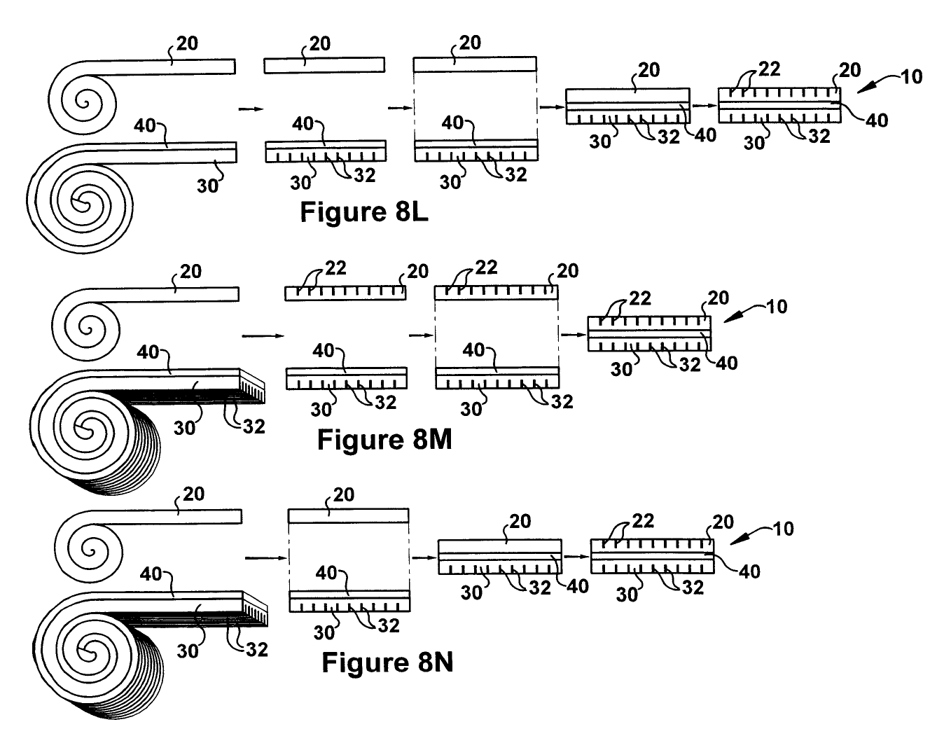

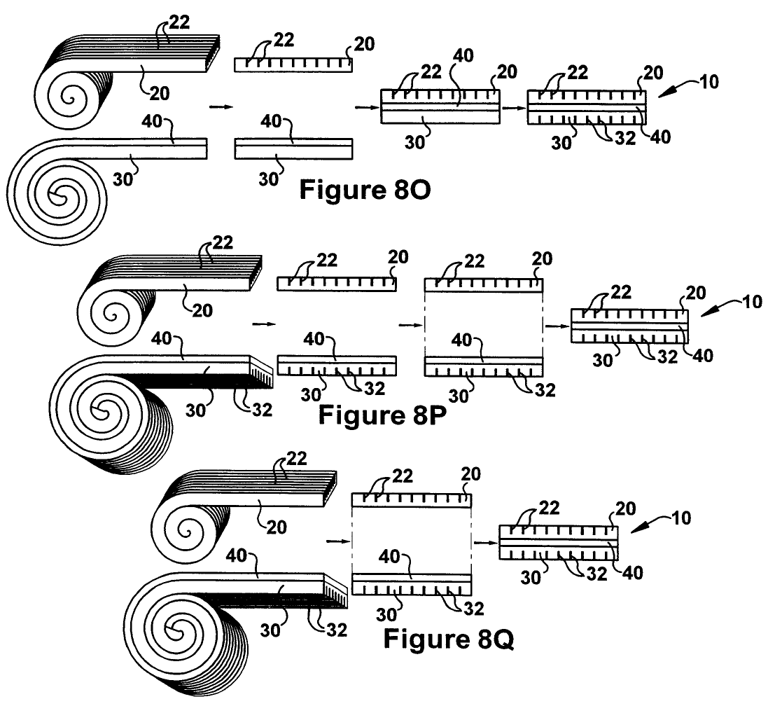

Referring now to FIGS. 8A-8Q, more possible methods for making the two-fabric-layer laminate 10 are shown. In these methods, the elastic layer 40 can be laminated to one of the fabric layers 20/30 and the sublaminate 20/40 or 30/40 assembled into a format suitable for continuous supply (e.g., a roll). As with the preceding schematic method drawings, the continuous supply of the sublaminate is shown in the machine direction M, while the subsequent steps are shown in the cross direction C.

The method can comprise laminating the first fabric layer 20 to the elastic layer 40 to form a sublaminate 20/40 (FIGS. 8A-8H). The first fabric layer 20 in the sublaminate 20 can not yet be interrupted (FIGS. 8A-8E). In this case, the first-fabric-interruption-forming step can be performed after the second-fabric-laminating step (FIGS. 8A, 8C, and 8D) or before the second-fabric-laminating step (FIGS. 8B and 8E). The second-fabric-interruption-forming step can be performed after the laminating step (FIGS. 8A and 8B), before the laminating step (FIG. 8C), after the first-fabric-interruption-forming step (FIG. 8B), and/or before the first-fabric-interruption-forming step (FIG. 8C).

The first fabric layer 20 in the sublaminate 20/40 can already be interrupted (FIGS. 8F-8H), in which case the second-fabric-interruption-forming step can be performed after the second-fabric-laminating step (FIG. 8F) or before the second-fabric-laminating step (FIG. 8G). The second fabric 30 can also be supplied with interruptions 32, in which case the only remaining step will be laminating the second fabric 30 to the sublaminate 20/40 (FIG. 8H). FIGS. 8I-8Q show methods similar to those shown in FIGS. 8A-8H, except that the second fabric layer 30 can be pre-laminated to the elastic layer 40 to form a sublaminate 30/40. Again, the formation of interruption-forming steps on the laminate 20/30/40 (FIGS. 8A-8D, 8F, 8I, 8K-8O), the sublaminate 20/40 (FIGS. 8B and 8E), and/or the sublaminate 30/40 (FIGS. 8J and 8L), may be best accomplished with laser, ultrasound, and/or other more precise cutting procedures.

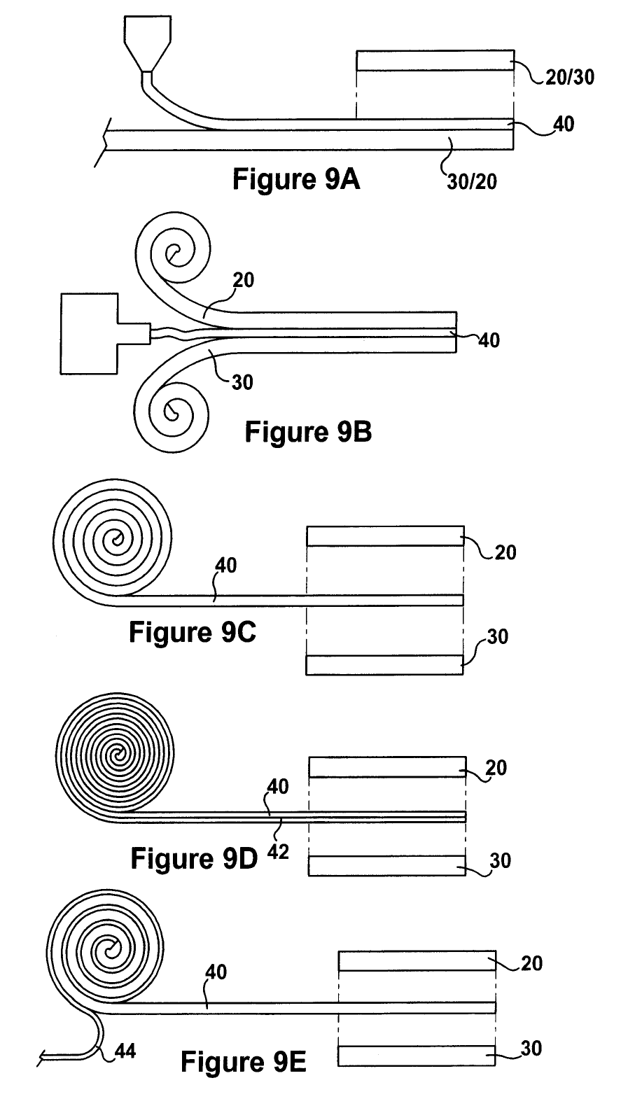

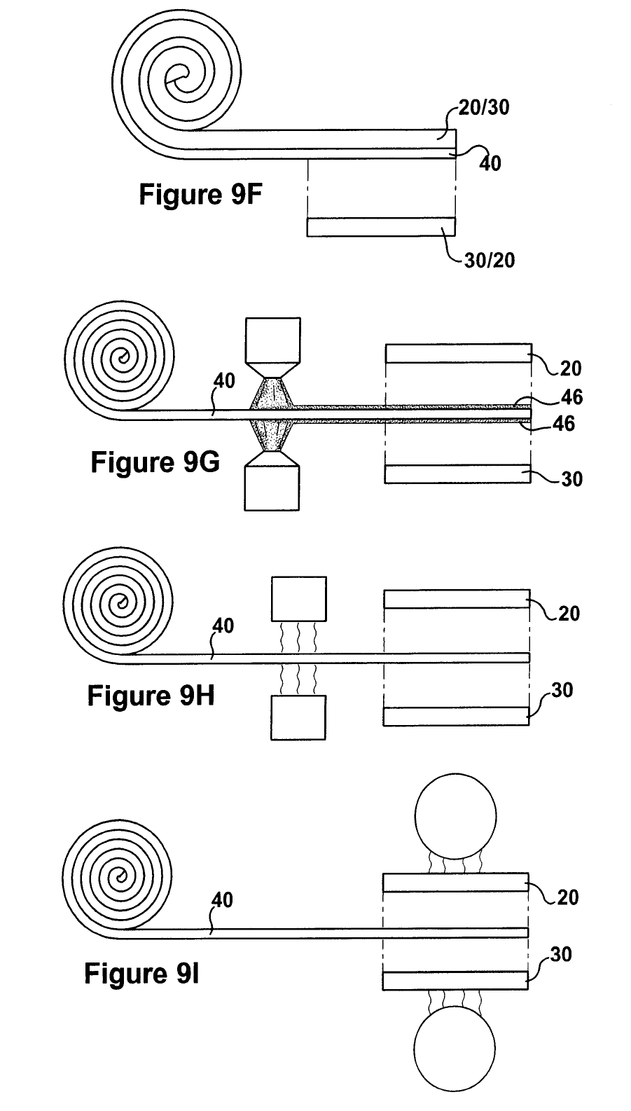

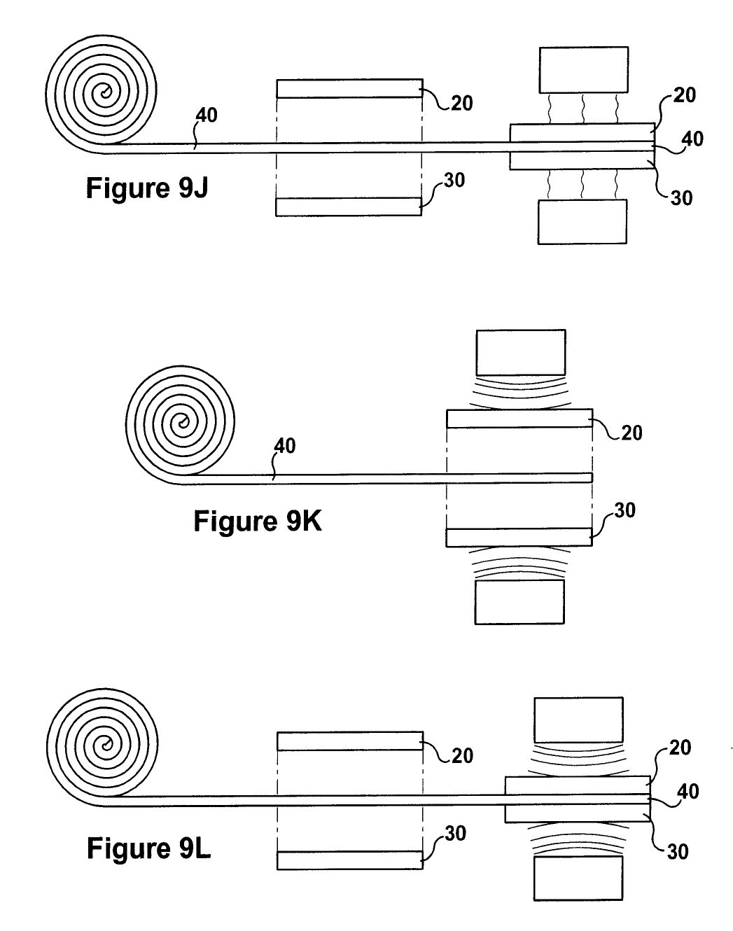

FIGS. 9A-9F show some possible techniques for laminating the fabric layer 20 and/or the fabric layer 30 to the elastic layer 40. One technique is to extrude the elastic layer 40 directly on the fabric layer 20/30 and then laminate the other layer 30/20 thereon (FIG. 9A). Alternatively, the elastic layer 40 can be simultaneously (or substantially simultaneously) extruded onto both the fabric layer 30 and the fabric layer 40 (FIG. 9B).

The elastic layer 40 can be provided as a pre-formed film in a format suitable for continuous supply (e.g., a roll) and the fabric layers 20 and 30 laminated thereon (FIGS. 9C-9E). With certain formulations, the elastic layer 40 can be provided as monolayer (FIG. 9C). Otherwise, the elastic material may be “sticky” whereby film-to-film contact may cause blocking. To avoid these “stickiness” and/or “blocking” issues, and still be able to use preformed elastic film in a continuous form, a skin or thin fabric sublayer 42 can be laminated to one side of the elastic film layer 40 (FIG. 9D). Alternatively, a liner 44 can accompany the elastic film layer 40 on the roll and then be removed prior to lamination to the fabric layer 30/20 (FIG. 9E).

Instead of employing a sublayer 42 or a liner 44, one of the fabric layers 20/30 can be laminated to the elastic layer 40 prior to assembling it in a format suitable for continuous supply (FIG. 9F). (See also the methods shown in FIGS. 8A-8Q). This eliminates any “stickiness” and/or “blocking” issues, and allows a continuous supply of “skinless” or “linerless” elastic without having to resort to extrusion.

In extrusion techniques (FIG. 9A-9B), the molten quality of the elastic material will usually be sufficient to bond the fabric layers 20/30 to the elastic layer 40 (or sublayer 42) during lamination. However, in non-extrusion techniques (FIGS. 9C-9F), additional steps may be necessary.

In non-extrusion lamination techniques, an adhesive can be applied to the layer 20/30 prior to lamination (FIG. 9G) whereby an adhesive sublayer 46 will be positioned between the bonding surfaces of the fabric layers 20/30 and the elastic layer 40. The adhesive can comprise hot-melt adhesives (e.g., hot-melt rubber-based materials or acrylic-based materials) and/or non-hot-melt adhesives, such as pressure sensitive adhesives, polyurethane adhesives and structural adhesives. The adhesive sublayer(s) 46 can extend across the entire bonding area, or can be applied in intermittent adhesive patterns (e.g., stripes, spots, swirls, islands, grids, checkerboard, voids, random, semi-random, etc.). Although not specifically shown in the drawings, an adhesive sublayer 46 can be positioned only between one fabric layer 20/30 and the elastic layer 40, with the other fabric layer 30/20 being secured to the elastic layer 40 in another manner. Also, in the case of the elastic layer having a skin or liner sublayer 42, the adhesive sublayer 46 would be positioned between the skin/liner and the fabric layer 20/30.

Instead of adhesive bonding, radiant heat can be used to melt the fabric layers 20/30 and/or the elastic layer 40 into a molten state which will then bond the layers together upon cooling (FIGS. 9H-9J). For example, heat can be applied upstream of layer-compiling (FIG. 9H), during layer-compiling (FIG. 9I), or downstream of layer-compiling (FIG. 9J). With particular reference to a heat-applying step during layer-compiling (FIG. 9I), the heat can be supplied, for example, through the laminating rollers. Although in the illustrated technique heat is applied to both sides of the laminate 10, in many cases heat application to just one side may be sufficient.

Ultrasonic bonding and/or welding can also be used when laminating the fabric layer(s) 20/30 to the elastic layer 40 (FIGS. 9K and 9L). This ultrasonic step can be performed during layer compiling (FIG. 9K) or after layer compiling (FIG. 9L). Again, although ultrasonic energy is being applied to both sides of the laminate 10 in the illustrated embodiment, one side application may be sufficient.

The first fabric layer 20 and the second fabric layer 30 need not be bonded to the elastic layer 40 in the same manner, and the bonding techniques can be appropriately intermixed. For example, one fabric layer 20/30 can be joined to the elastic layer 40 through extrusion, while the other fabric layer 30/20 can be joined to the elastic layer 40 through adhesive, heat, or ultrasonic procedures. One fabric layer 20/30 can be bonded to the elastic layer 40 via adhesive bonding and the other fabric layer 30/20 can be bonded to the elastic layer 40 via heat or ultrasonic bonding.

At least some of the interruption-forming steps and/or the laminating steps can be performed in-line for production efficiency purposes. In an in-line production process, the first fabric layer 20 and the second fabric layer 30 will each usually be provided in a format (e.g., a roll) suitable for continuous supply. The fabric layer 40 will usually be supplied in a format (e.g., a roll) suitable for continuous supply. A further option is for the fabric layer 20 and/or the fabric layer 30 to be formed by extrusion and, if so, coextrusion of a plurality of the layers (e.g., layers 20 and 40, layers 30 and 40, and/or layers 20, 30 and 40) is also possible. With this option, the interruption-forming steps would be formed downstream of the extrusion laminating steps for the relevant fabric layer(s) 20/30, unless the extruding step incorporates an interruption-forming step.

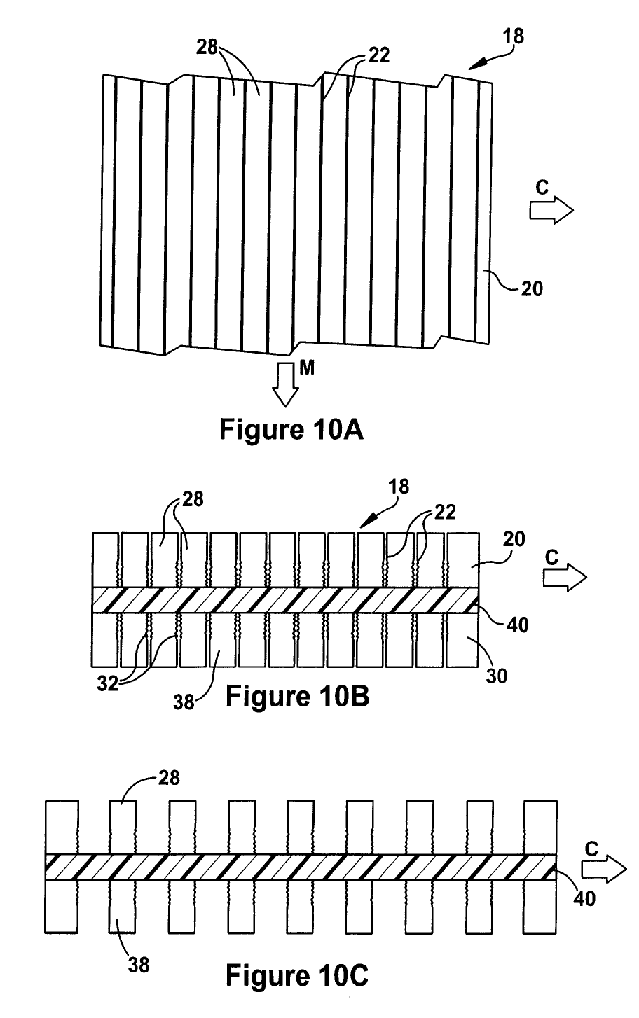

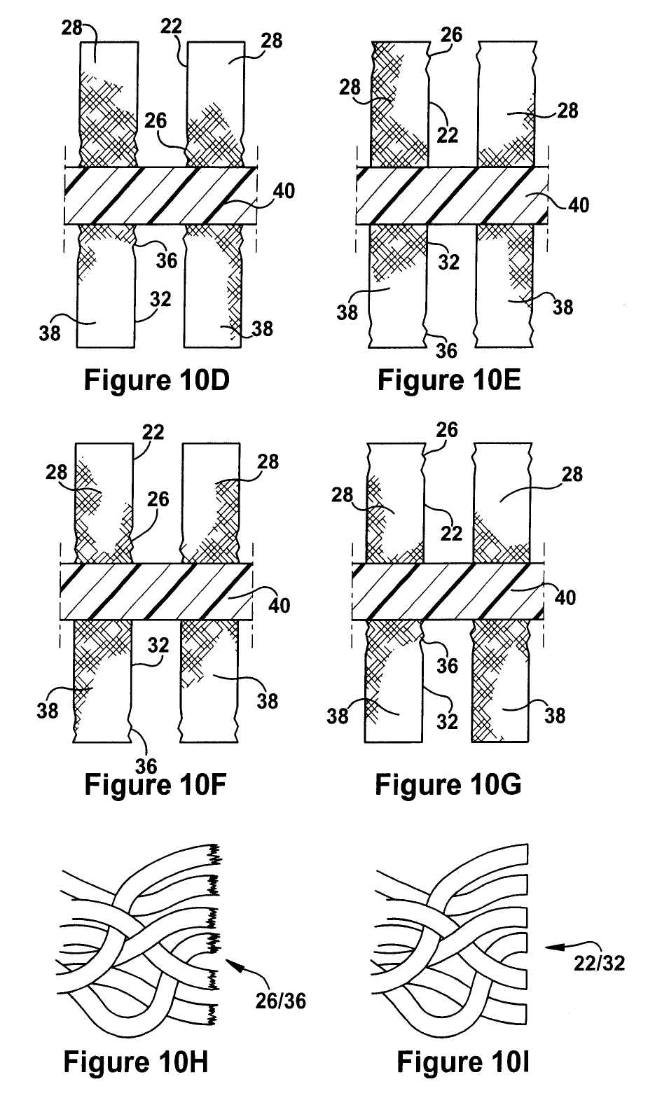

The stretchable laminate 10 can be a finished product ready for incorporation into a diaper component (e.g., side panel 50 introduced below, fastening tape 70 introduced below, and/or diaper chassis 92). In such a case, the interruptions 22/32 extending partially through the fabric thicknesses provides sufficient stretchability and/or elasticity for the given diaper situation. Alternatively, the stretchable laminate 10 can serve as an intermediate product when making an elastic (or more elastic) laminate 18 such as the one shown in FIGS. 10A-10C.

In the elastic laminate 18, interruptions are formed in the tendons 24/34. The tendon interruptions 26/36 are best seen in FIGS. 10D-10G and, as shown, these tendon interruptions 26/36 and the initial interruptions 22/32 in the intermediate laminate 10, together extend completely through the thickness of the fabric layer(s) 20/30. If the initial interruptions 22/32 are distal interruptions, the tendon interruptions 26/36 will be proximal interruptions (interruptions 22/26 and 32/36 in FIG. 10D, interruptions 22/26 in FIG. 10F and interruptions 32/36 in FIG. 10G). If the intermediate interruptions 22/32 are proximal interruptions, the tendon interruptions 26/36 will be distal interruptions (interruptions 22/26 and 32/36 in FIG. 10E, interruptions 32/36 in FIG. 10F, and interruption 22/26 in FIG. 10G.)

The tendon-interrupting step results in the fabric layers 20/30 comprising separate fabric segments 28/38. The fabric segments 28/38 are attached to the elastic layer 40 and diverge upon laminate elongation (FIG. 10C) and converge upon laminate recovery (FIG. 10B). The elastic layer 40 can be visible between the fabric segments 28/38 when the laminate 10 is elongated and/or can be hidden by the fabric segments 28/38 when the laminate 10 is not elongated.

If the tendon interruptions 26/36 are formed by rupturing the tendons 24/34, this interruption will be defined by primarily fractured fabric strand ends, that is, fabric strand ends which have been broken roughly and/or unevenly, as shown schematically in FIG. 10H. If the initial interruptions 22/32 are die-cut, kiss-cut, slit, scored, laser-cut, ultrasound cut, or otherwise sharply split, they will be defined by primarily severed fabric strand ends, that is, fabric strand ends which have been severed cleanly and neatly, as shown schematically in FIG. 10I.

The rupturing can be accomplished by applying an integrative rupturing force over the laminate width or portions thereof (e.g., tentering or zone-stretching), by applying a series of discrete rupture-inducing forces (e.g., corrugated rupturing rolls), or by any other suitable technique. The tendon interruptions 26/36 can instead be formed by other separating methods (e.g., cutting, slitting, scoring, sawing, etc.), if care is taken to insure that this separation step does not seriously flirt with the danger of damaging the elastic layer 40. In the latter case, laser, ultrasound, and/or other accurate non-contacting cutting techniques may remove the risk of elastic-related casualties.

The tendon-interrupting step can be performed immediately following and/or in-line with the steps for making the stretchable laminate 10. If an elastic laminate 18 is to be incorporated into a diaper component, the tendon-interrupting step can be before or after the intermediate laminate 10 is incorporated into the diaper component and/or before or after this component is installed in the diaper. The diaper can be provided to the end user with the tendons 24/34 intact (and thus including the stretchable laminate 10) and the tendon interrupting steps can be performed by the end user of the diaper. For example, such a force could be applied during the initial fitting of the diaper. Subsequent and/or hybrid tendon-interrupting steps could also be applied at different stages of diaper incorporation. For an example, the tendon 24/34 could be partially ruptured prior to incorporation of the diaper component and then completely ruptured during assembly/installation of the diaper component. For another example, the tendon 24/34 could be partially ruptured prior to use of the diaper and then completely ruptured by the end user. Also, the tendons 24/34 of one fabric layer 20/30 could be ruptured prior to use of the diaper, and the tendons 34/24 of the fabric layer 30/20 left at least partially intact for rupture by the end user.

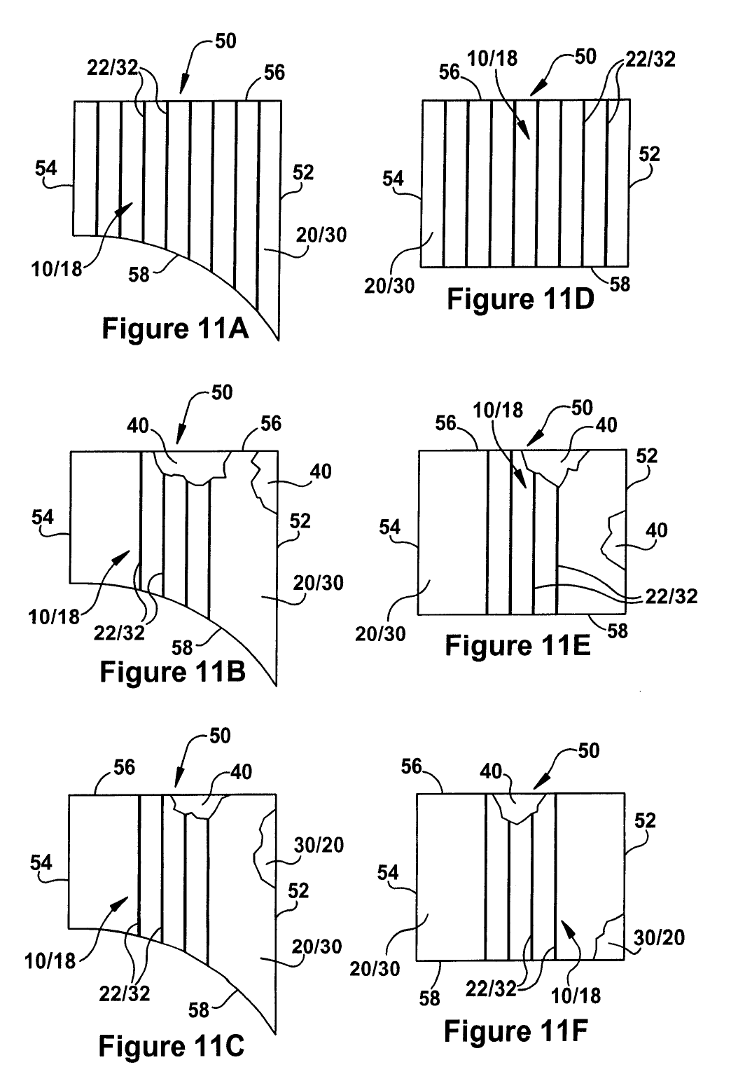

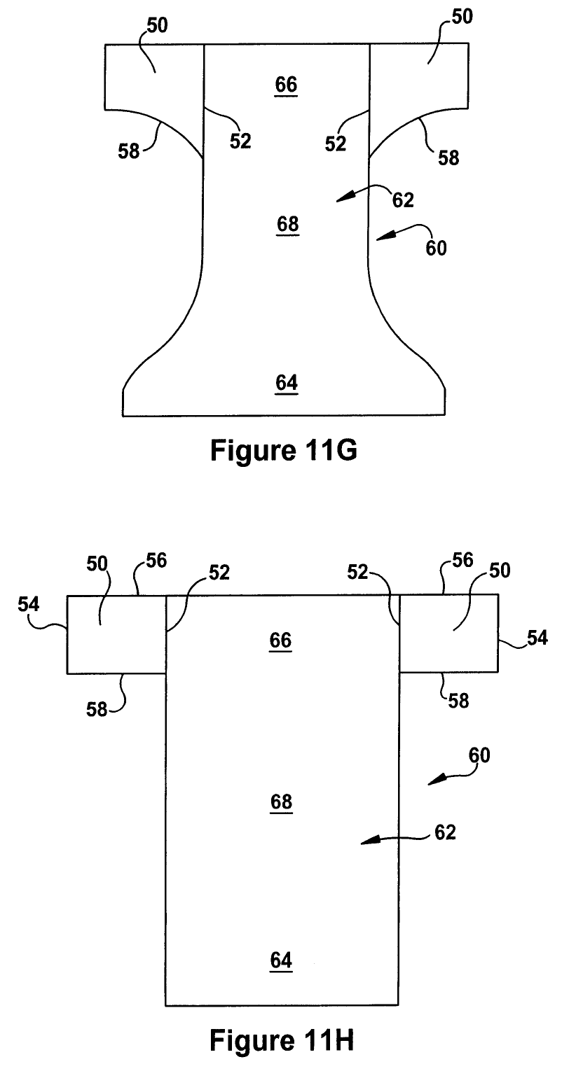

Referring now to FIGS. 11A-11F, a side panel 50 including the stretchable laminate 10 or the elastic laminate 18 is shown. The side panel 50 comprises a proximal edge 52, a distal edge 54, an upper edge 56, and a lower edge 58. In an absorbent disposable article 60 (comprising a chassis 62 having a front portion 64, a rear portion 66, a crotch portion 68), the proximal edge of 52 of a side panel 50 is joined to each lateral edge of the chassis rear portion 66 (FIGS. 11G and 11H). The chassis 62 can (or cannot) also incorporate the stretchable laminate 10 (e.g., chassis 92 introduced below).

With a baby diaper (FIG. 11G), the lower edge 58 of the side panel 50 can be convexly curved (FIGS. 11A-11C). With an adult incontinence brief (FIG. 11H), the upper edge 56 and the lower edge 58 can be parallel and substantially perpendicular to the proximal edge 52 and/or the distal edge 54 (FIGS. 11D-11F). The first fabric layer 20 can be the next-to-the-skin layer and/or the second fabric layer 30 can be the exposed layer. Alternatively, the first fabric layer 20 can be the exposed layer and/or the second fabric layer 30 can be the next-to-the-skin layer.

With the side panel 50, the cross direction C corresponds to the proximal-distal direction. The machine direction M corresponds to the upper-lower direction. Thus, the side panel 50 is stretchable in the proximal-distal direction and the interruptions 22/32 extend in the upper-lower direction.

The side panel 50 can carry a fastener for attaching its distal edge 54 to the front chassis portion 64 during the diapering process. The fastener can comprise a fastening tape (with attachment means) attached to the side panel 40 and projecting beyond its distal edge 54. Additionally or alternatively, attachment means can be situated on the side panel 50 itself, adjacent the distal edge 54. The attachment means can comprise, for example, mechanical fastening elements (e.g., hooks/loops), adhesive/cohesive area (s), magnetic connections, etc. If the side panel 50 carries a fastening tape, this fastening tape can (or cannot) also incorporate the stretchable laminate 10 (e.g., the fastening tape 70 introduced below).

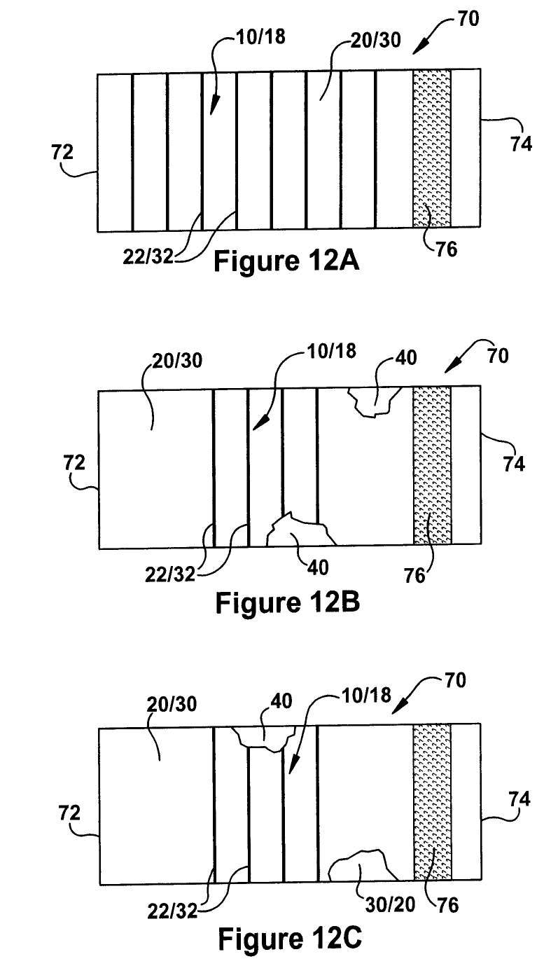

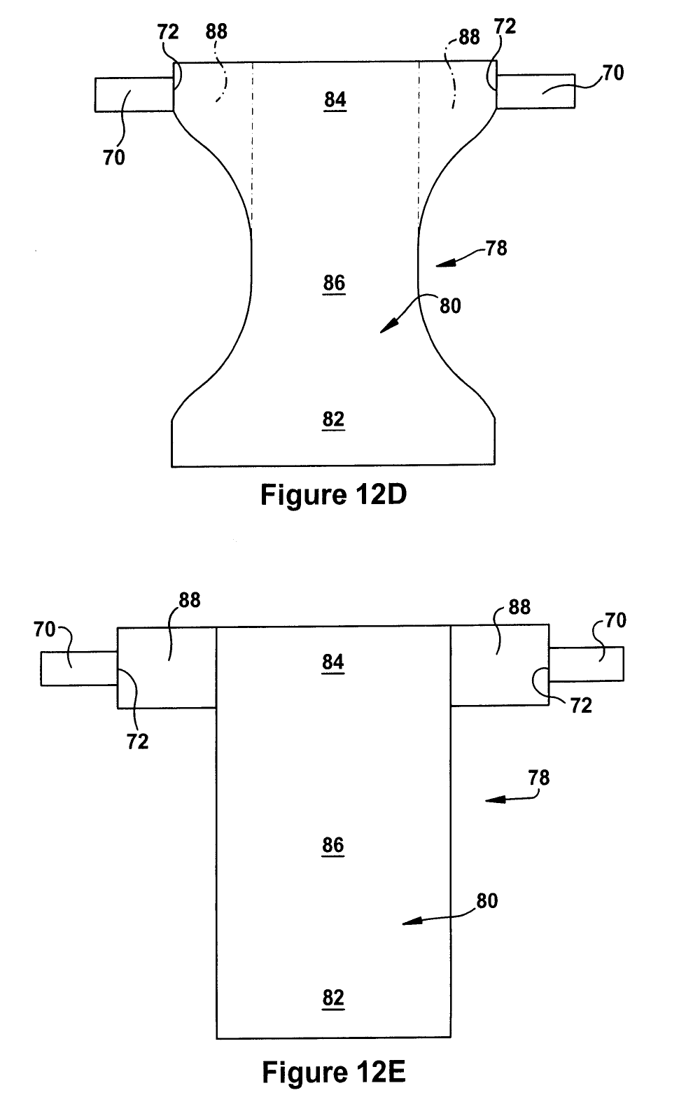

Referring now to FIGS. 12A-12C, a fastening tape 70, having a manufacturer end 72 and a user end 74, includes a stretchable laminate 10 and/or an elastic laminate 18. The fastening tape 70 can comprise attachment means 76 (e.g., mechanical elements such as hook/loops, adhesive/cohesive area(s), magnetic connections etc.) adjacent its user end 74. When used on an absorbent disposable article 78 (comprising a chassis 80, having a front portion 82, a rear portion 84, and a crotch portion 86, and possible side panels 88), the manufacturer end 72 is joined to the rear chassis portion 84 or the side panel 88 (FIGS. 12D and 12E.) The user end 74 is for selective attachment to the front portion 82 of the disposable absorbent article 78 via the attachment means 76. The chassis 80 and/or the side panel 88 can (or cannot) also incorporate the stretchable laminate 10 (e.g., the chassis 112 introduced below and/or the side panel 50 discussed above). The cross direction C in the tape 70 can correspond to its length (i.e., direction between the manufacturer end 72 and the user end 74) and the machine direction M can correspond to its width.

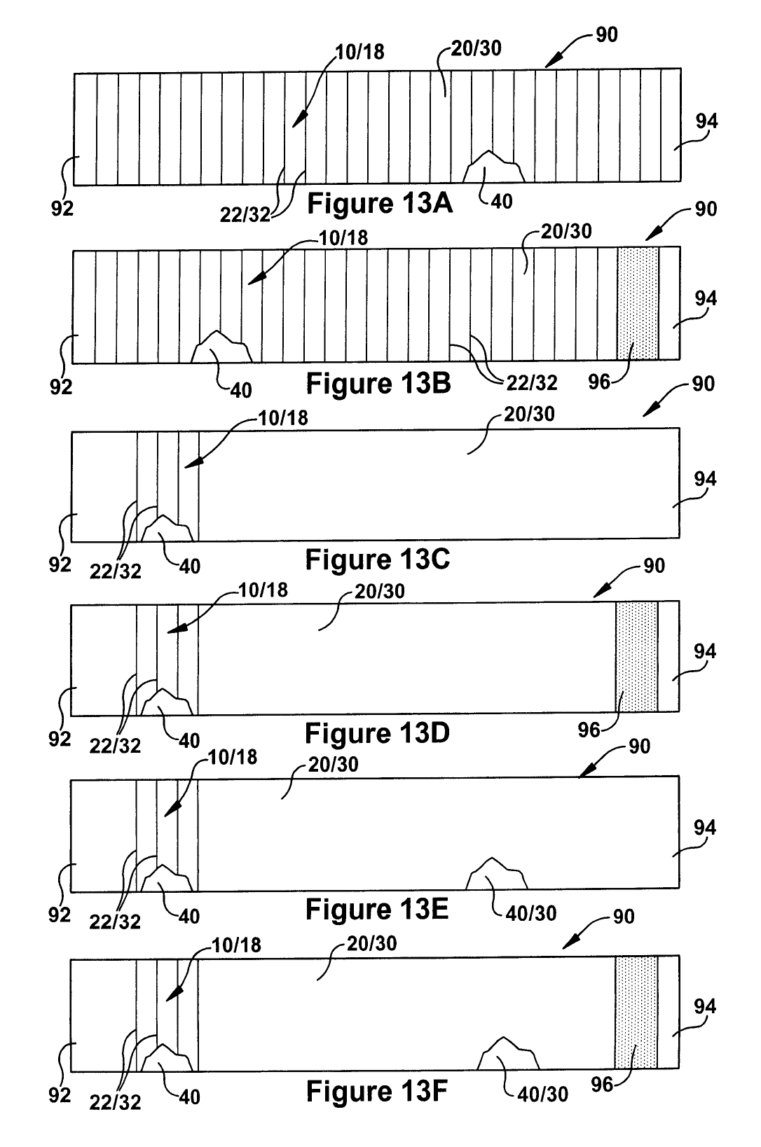

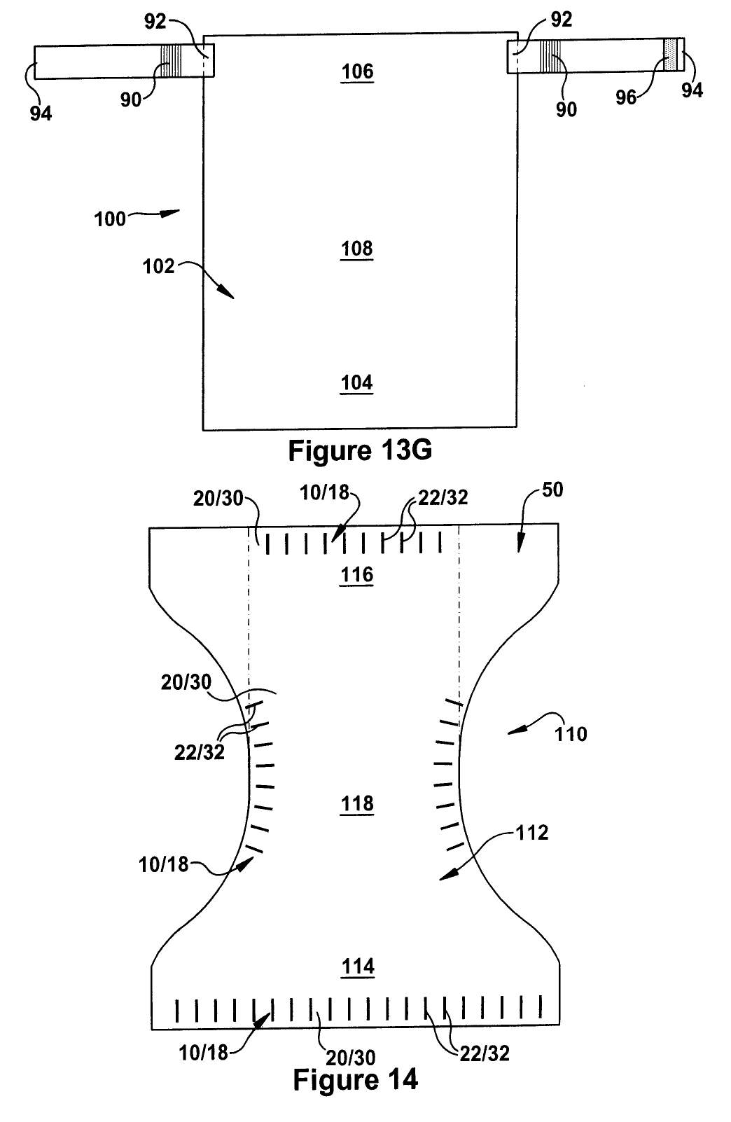

Referring now to FIGS. 13A-13G, one or more belts 90 can include a stretchable laminate 10 and/or an elastic laminate 18. The belt's cross direction C can correspond to its length (i.e., direction between the manufacturer end 92 and the user end 94) and the machine direction M can correspond to its width. The laminate 10/18 can span the entire belt length (FIGS. 13A and 13B) and/or the elastic layer 40 can span the entire belt length (FIGS. 13A-13D). The laminate 10/18 can span only a portion of the belt length (FIGS. 13C-13F), and can be situated centrally, towards the manufacturer's end 92 (as shown) or towards the user's end 94.

At least one belt 90 (FIGS. 13B, 13D, and 13F) can comprise attachment means 96 (e.g., mechanical elements such as hook/loops, adhesive/cohesive area(s), magnetic connections etc.) adjacent its user end 94. When used on an absorbent disposable article 98 (comprising a chassis 100, having a front portion 102, a rear portion 104, and a crotch portion 106), the manufacturer end 92 of each belt 90 is joined to the rear chassis portion 104. (FIG. 13G.) One belt 90 (FIGS. 13A, 13C, and 13E) can be folded around the user's waist and the other belt 90 (FIGS. 14B, 14D, and 14F) can be folded thereover. The belts 90 are held in position by the attachment means 96. The chassis 100 can (or cannot) also incorporate the stretchable laminate 10 (e.g., the chassis 112 introduced below).

Referring now to FIG. 14, a disposable absorbent article 110 is shown, the article 110 comprising a chassis 112 (having a front portion 114, a rear portion 116, and a crotch portion 118) including a stretchable laminate 10 and/or an elastic laminate 18. The laminate 10/18 can form at least part of the front portion 114 of the chassis 112 (e.g., a waist region), at least part of the rear portion 116 of the chassis 112 (e.g., a waist region), and/or at least part of the crotch portion 118 of the chassis 112 (e.g., leg-opening regions). The article 110 can (or cannot) include a side panel incorporating the laminate 10/18 (e.g., the side panel 50 introduced above), a fastening tape incorporating the laminate 10/18 (e.g., the fastening tape 70 introduced above), and/or belts incorporating the laminate 10/18 (e.g., the belts 90 introduced above).

In the side panel 50, the tape 70, the belt 90, and the absorbent disposable article 110, the laminate 10/18 can include, or not include, any of the features discussed above. For example, the interruptions 22/32 can be continuously spaced (or not) in the cross direction C, the interruptions 22/32 can completely (or only partially) extend the span of the machine direction M, the elastic layer 40 can be coextensive (or not) with the fabric layers 20/30 and/or the elastic layer 40 can only be coextensive with the interruptions 22/32.

If the fabric layer(s) 20/30 are nonwoven layers (e.g., nonelastic nonwoven layers), they can be, for example, polyolefin, such as polyethylene and/or its copolymers, or polypropylene and/or its copolymers, or mixtures of the aforementioned polyolefins, polyurethanes, polyester, polyether or polymide. The nonwoven materials can comprise, for example, spunbonded webs, meltblown webs, air laid layer webs, bonded carded webs, hydroentangled webs, wet-formed webs or any combination thereof. The nonwoven layers can have a weight of about 10 gsm to about 100 gsm and the layers 20/30 can vary in weight.

The layers 20/30 can be fabric monolayers, that is a single layer of fabric rather than a laminate of a plurality of sublayers. For example, a monolayer structure wherein fibers or other filaments are fused or otherwise integrated into a single substrate layer, can be employed. While monolayer constructions will be preferred in many situations, the layers 20/30 could alternatively have a multilayer construction (i.e., a compilation or lamination of layers wherein different layers are distinguishable and/or separable).

The elastic layer 40 can comprise an elastomer selected from the group consisting of styrene block copolymers, polyurethanes, polyesters, polyethers, and polyether block copolymers. Additionally or alternatively, the elastic layer 40 can comprise a vinyl arene-containing block copolymer (e.g., a block copolymer comprising SBS and/or SEBS). The term “elastic” (or related terms such as “elasticized” and “elasticity”) means that the layer tends to recover to or near its original size and shape after removal of a force causing a deformation. For example, an elastic material or composite can be elongated by at least 50% of its relaxed length and which will recover, upon release of the applied force, at least 40% of its elongation. For example, the elastic layer 40 can be capable of being elongated by at least 100% to 300% of its relaxed length and recover, upon release of an applied force, at least 25% to 50% of its elongation.

The machine direction M refers to the production direction of the laminate 10. This may (or may not) be different than the machine direction when producing the side panels 50, the fastening tape 70, the belts 90, or the chassis 112 of the disposable article 110. The machine direction M may (or may not) be different than the machine direction joining the side panels 50 to the absorbent disposable article 60, securing the tape 70 to the chassis 80 (or side panel 88) of the disposable article 78, or attaching the belts 90 to the absorbent article 98.

One may now appreciate that the stretchable laminate 10 can be provided for use in a diaper component. The stretchable laminate 10 can be incorporated into the diaper component and/or it can serve as an intermediate product for making an elastic (or more elastic) laminate 18 for incorporation into the diaper component.

1. An elastic laminate comprising a first fabric layer and an elastic layer laminated thereto;
wherein the elastic layer is made of an elastic material that has recoverable elongation properties in a direction (C) cross from the machine direction (M);
wherein the first fabric layer comprises separate fabric segments attached to the elastic layer which diverge upon elongation and converge upon recovery;
wherein the separate fabric segments are formed by initial interruptions which extend through 10% to 99% of the layer thickness and tendon interruptions which extend from the interruptions through the remaining 90% to 1% of the layer thickness.

2. An elastic laminate as set forth in claim 1, wherein the initial interruptions comprise severed fabric ends and wherein the tendon interruptions are ruptured and comprise fractured fabric ends.

3. An elastic laminate as set forth in claim 2, wherein the first fabric layer is a nonwoven layer.

4. An elastic laminate as set forth in claim 3, wherein the first fabric layer is a nonelastic layer.

5. An elastic laminate as set forth in claim 1, further comprising a second fabric layer and wherein the elastic layer is sandwiched between the first fabric layer and the second fabric layer.

6. An elastic laminate as set forth in claim 5 wherein the first fabric layer is a nonwoven fabric layer and the second fabric layer is a nonwoven fabric layer.

7. An elastic laminate as set forth in claim 5, wherein the elastic layer is non-coextensive with the fabric layers in the cross direction (C).

8. An elastic laminate as set forth in claim 7, wherein the elastic layer is substantially coextensive with the fabric layer(s) in the machine direction (M).

9. An elastic laminate as set forth in claim 8, wherein the initial interruptions and the tendon interruptions do not extend beyond the extent of the elastic layer in the cross-direction (C).

10. An elastic laminate as set forth in claim 9, wherein the initial interruptions and the tendon interruptions extend almost, but not quite the full cross-extent of the elastic layer to leave an uninterrupted margin aligned each lateral edge of the elastic layer.

11. A stretchable laminate as set forth in claim 10, wherein the uninterrupted margins have a width in the range of 2 mm to 20 mm.

12. An elastic laminate as set forth in claim 5, wherein the second fabric layer has initial interruptions which extend through 10% to 99% of the layer thickness and tendon interruptions which extend from the initial interruptions through the remaining 90% to 1% of the layer thickness.

13. A method of making the elastic laminate set forth in claim 1, comprising the steps of:
forming the initial interruptions in the first fabric layer;
laminating the first fabric layer and the elastic layer; and
forming the interruptions in the tendons to form the separate fabric segments.

14. A method as set forth in claim 13, wherein said initial-interrupting step comprises severing the first fabric layer and wherein said tendon-interrupting step comprises rupturing the tendons.

15. A method as set forth in claim 14, wherein said rupturing step comprises breaking or tearing the tendons.

16. A method as set forth in claim 14, wherein said initial interrupting step is performed before said fabric-laminating step and wherein said tendon-interrupting step is performed after said fabric-laminating step.

17. A method as set forth in claim 16, wherein said tendon-interrupting step is performed in-line with said fabric-laminating step.

18. A side panel having a proximal edge for attachment to a lateral edge of a rear portion of a chassis of an absorbent article, a distal edge, an upper edge, and a lower edge; wherein the side panel includes the laminate set forth in claim 1.

19. A disposable absorbent article comprising a chassis having a front portion, a rear portion, a crotch portion, and a pair of the side panels set forth in claim 18, wherein one side panel is attached to each lateral edge of the rear portion.

20. A method of making the elastic laminate set forth in claim 12, comprising the steps of:
forming the initial interruptions in the first fabric layer;
forming the initial interruptions in the second fabric layer;
laminating the first fabric layer and the elastic layer;
laminating the second fabric layer and the elastic layer;
forming interruptions in the tendons in the first fabric layer to form its separate fabric segments; and
forming interruptions in the tendons in the second fabric layer to form its separate fabric segments.

21. A method as set forth in claim 20, wherein said initial-interrupting steps comprise severing the fabric layers and wherein said tendon-interrupting steps comprise rupturing the tendons.

22. A method as set forth in claim 21, wherein said rupturing steps comprise breaking or tearing the tendons.

23. A method as set forth in claim 21, wherein said initial-interrupting steps are performed before said fabric-laminating steps and wherein said tendon-interrupting steps are performed after said fabric-laminating steps.

24. A method as set forth in claim 23, wherein said tendon-interrupting steps are performed in-line with said fabric-laminating steps.

25. A side panel having a proximal edge for attachment to a lateral edge of a rear portion of a chassis of an absorbent article, a distal edge, an upper edge, and a lower edge; wherein the side panel includes the laminate set forth in claim 12.

26. A disposable absorbent article comprising a chassis having a front portion, a rear portion, a crotch portion, and a pair of the side panels set forth in claim 25, one side panel being attached to each lateral edge of the rear portion.
